(19) United States
(12) Patent Application Publication
(10) Pub. No.: US 2022/0398645 A1
(43) Pub. Date: Dec. 15, 2022

(54) SUBSCRIPTION-BASED MAKEUP BRUSH CLEANING SYSTEM

(71) Applicant: Ahata LLC, Omaha, NE (US)

(72) Inventors: Stamatina Stambolis, Omaha, NE (US); Monica Bhatia, Omaha, NE (US)

(21) Appl. No.: 17/344,396

(22) Filed: Jun. 10, 2021

(51) Int. Cl. G06Q 30/06; G06Q 10/08; A46B 17/06; A46B 15/00

(52) U.S. Cl. CPC G06Q 30/0633; G06Q 30/0627; G06Q 10/083; A46B 17/06; A46B 15/0085; A46B 2200/1046

(57) ABSTRACT

A system is disclosed that includes a server, which includes a network interface configured to receive an order request for one or more ordered products from an end device. The order request includes user identification information, product identification information, and time interval information. The system further includes a memory and a processor configured to access the memory and operate according to computer program code. The computer program code includes product code, product status code, which causes the processor to acquire a first status (product location) and a second status (condition state) of one of the one or more ordered products. The computer program code further includes product transport code configured to cause the processor to determine a transport location based on the acquired information, and generate an instruction to send the one of the one or more ordered products to a storage facility, a reconditioning facility, or a user.

### BACKGROUND

Subscription-based services allow a consumer to purchase products, whether virtual or nonvirtual, on a timely basis. For nonvirtual products, subscription-based services allow a consumer to receive new consumer products (e.g., razor blades, or pajamas) on a monthly or other time unit. Subscription-based services are also used to distribute returnable used products that, once used, are still usable in their present form, such as DVD movies from a DVD subscription service. DVDs are well suited for distribution via subscription-based services of returnable products due to the relative stability of the DVD, a minimal need for reconditioning of the DVD, and that each DVD is not personally linked to a user. Accordingly, subscription-based services for returnable products may not be well suited for personally-linked products that require reconditioning, such as cleaning or repair.

Makeup brushes are a common tool for applying cosmetics to the body. Makeup brushes typically consist of a stem or handle having bristles on one end. The bristles are configured to pick up cosmetic material from a container, such as a cake of powder, and deposit the cosmetic material on the body, such as a cheek or forehead. Over time, makeup brushes often become dirty and/or matted with cosmetic material. Cleaning cosmetic brushes can be troublesome due to the adherence of the cosmetic material to the bristles. Although makeup brushes may be discarded and new makeup brushes may be purchased, many makeup brushes are constructed of high quality and expensive materials that would make rebuying of brushes cost-prohibitive. Therefore, it would be advantageous to provide a solution that cures the shortcomings described above.

### SUMMARY

A system is disclosed. In some embodiments, the system includes a server. In some embodiments, the server includes a network interface configured to receive an order request from an end device for one or ordered products. In some embodiments, the order request comprises user identification information configured to identify a user. In some embodiments, the order request further includes product identification information configured to identify the one or more ordered products. In some embodiments, the order request further includes time interval information for the one or more ordered products, wherein the time interval information is configured as an indicated time for at least one of the one or more ordered products to be shipped to a reconditioning facility. In some embodiments, the system further includes one or more memory configured to store computer code. In one or more embodiments, the system further includes one or more processors configured to access the at least one memory and operate according to the computer program code, In some embodiments, the product code includes product code configured to cause at least one of the one or more processors to acquire product description information of the least one of the one or more ordered products; based on the product identification number information of the order product from a product description database. In some embodiments, the computer program code further includes product status code configured to cause at least one of the one or more processors to acquire product status information based on a first status of the at least one of the one or more ordered products and a second status of at least one of the one or more ordered products, wherein the first status is a product location of the at least one of the one or more ordered products, wherein the second status is a condition state of the at least one of the one or more ordered products. In one or embodiments, the computer code further includes product transport code configured to cause the one or more processors to receive user identification, product identification information, time interval information, and product status information, determine a transport location based on the user identification, the product identification information, the time interval information, and product status information, and generate an instruction, wherein the instruction comprises at least one of sending at least one of the one or more ordered products to the user, sending at least one of the one or more ordered products to a storage facility, or sending a notice to the user requesting the user to send at least one of the one or more ordered products to the reconditioning facility.

In some embodiments of the system, the system further includes a product labeling apparatus communicatively coupled to the server and configured to label the at least one of the one or more ordered products with a product label configured to include least one of the user identification information, the product identification information, or the time interval information.

In some embodiments of the system, the product label includes a barcode.

In some embodiments of the system, the system further includes a barcode scanner communicatively coupled to the server and configured to scan the barcode.

In some embodiments, the notice includes at least one of a mailing label or a pre-paid return container, wherein the at least one of a mailing label or prepaid return container labeled with the mailing address of the reconditioning facility.

In some embodiments, the reconditioning facility is configured to clean the at least one of the one or more ordered products.

In some embodiments of the system, the at least one of the one or more ordered products is sent to the storage facility after cleaning.

In some embodiments of the disclosure, the at least one of the one or more ordered products is cleaned by a method. In some embodiments, the method includes vibrating the at least one of the one or more ordered products. In some embodiments, the method further includes wetting at least a portion of the at least one of the one or more ordered products with an aqueous solution. In some embodiments, the method further includes applying a disinfecting solution to the at least a portion of the least a one of the one or more ordered products. In some embodiments, the method further includes applying steam to the least a one of the one or more ordered products. In some embodiments. In some embodiments, the method further includes drying the least a one of the one or more ordered products.

In some embodiments of the system, the at least one of the one or more ordered products is configured as a cosmetic device.

In some embodiments of the system, the cosmetic device is further configured as a makeup brush or a set of makeup brushes.

In some embodiments of the system, the condition state comprises at least one of a dirty state, a clean state, or a damaged state.

In some embodiments of the system, the system further comprises at least one of the reconditioning facility or the storage facility.

In some embodiments of the system, the product location comprises at least one of the reconditioning facility, the storage facility, or a user address

A method is also disclosed. In one or more embodiments, the method includes receiving an order request from an end device to a network interface of a server for one or more ordered products. In one or more embodiments, the order request includes user identification information for identifying a user. In one or more embodiments, the order request further includes product identification information for identifying the one or more ordered products. In one or more embodiments, the order request includes time interval information for the one or more ordered products, wherein the time interval information is configured as an indicated time for at least one of the one or more ordered products to be shipped to a reconditioning facility, wherein the server comprises one or more memory configured to store computer program code and one or more processors configured to access the at least one memory and operate according to the computer program code. In one or more embodiments, the method includes determining product description information of at least one of the one or more ordered products, wherein the product description information is acquired from a product description database via at least one of the one or more processors utilizing the computer program code that includes a product code. In one or more embodiments, the method includes determining product status information of at least one of the one or more ordered products, wherein the product status information is based on a first status of the at least one of the one or more ordered products and a second status of at least one of the one or more ordered products acquired by the one or more processors utilizing the computer program code that includes a product status code, wherein the first status is a product location of the at least one of the one or more ordered products, wherein the second status is a condition state of the at least one of the one or more ordered products. In one or more embodiments, the method includes determining a transport location for the at least one of the one or more ordered products, wherein the transport location is based on the user identification, the product identification information, the time interval information, and product status information acquired by the one or more processors utilizing a computer program code that includes a product transport code. In one or more embodiments, the method includes generating an instruction based on the transport location, wherein the instruction includes at least one of sending at least one of the one or more ordered products to a user, sending the at least one of the one or more ordered products to a storage facility, or sending a notice to the user requesting the user to send the at least one of the one or more ordered products to the reconditioning facility. In one or more embodiments, the method includes sending at least one of the notice or the at least of the one or more ordered products based on the instruction.

In some embodiments of the method, the method further includes labeling the at least one of the one or more ordered products.

In some embodiments of the method, the method further includes cleaning the at least one of the one or more ordered products. In some embodiments of the method, the method further includes repairing the at least one of the one or more ordered products.

In some embodiments of the method, the cleaning the a least one of the one or more ordered products includes vibrating the at least one of the one or more ordered products. In some embodiments of the method, the cleaning the a least one of the one or more ordered products includes wetting at least a portion of the at least one of the one or more ordered products with an aqueous solution. In some embodiments of the method, the cleaning the a least one of the one or more ordered products includes applying a disinfecting solution to the at least a portion of the least a one of the one or more ordered products. In some embodiments of the method, the cleaning the a least one of the one or more ordered products includes applying steam to the least a one of the one or more ordered products. In some embodiments of the method, the cleaning the a least one of the one or more ordered products includes drying the least a one of the one or more ordered products.

In some embodiments of the method, the at least one of the one or more ordered products is configured as a cosmetic device.

In some embodiments of the method, the at least one of the one or more ordered products is further configured as a makeup brush, or a set of makeup brushes.

In some embodiments of the method, the condition state includes at least a dirty state, a clean state, or a damaged state.

This Summary is provided solely as an introduction to subject matter that is fully described in the Detailed Description and Drawings. The Summary should not be considered to describe essential features nor be used to determine the scope of the Claims. Moreover, it is to be understood that both the foregoing Summary and the following Detailed Description are example and explanatory only and are not necessarily restrictive of the subject matter claimed.

### BRIEF DESCRIPTION OF THE DRAWINGS

The detailed description is described with reference to the accompanying figures. The use of the same reference numbers in different instances in the description and the figures may indicate similar or identical items. Various embodiments or examples (“examples”) of the present disclosure are disclosed in the following detailed description and the accompanying drawings. The drawings are not necessarily to scale. In general, operations of disclosed processes may be performed in an arbitrary order, unless otherwise provided in the claims. In the drawings:

FIG. 1 is a flow diagram illustrating a system for reconditioning a product, in accordance with one or more embodiments of the disclosure;

FIG. 2 is a flow diagram illustrating a system for reconditioning a product, in accordance with one or more embodiments of the disclosure;

FIG. 3 is a block diagram illustrating hardware used for a system, in one or more embodiments of the disclosure;

FIG. 4 is a flow diagram illustrating a method for operating a subscription-based system for vending and reconditioning one or more ordered products, in accordance with one or more embodiments of the disclosure.

FIG. 5 is a flow diagram illustrating a method for cleaning one of one or more ordered products, in accordance with one or more embodiments of the disclosure.

### DETAILED DESCRIPTION

Before explaining one or more embodiments of the disclosure in detail, it is to be understood that the embodiments are not limited in their application to the details of construction and the arrangement of the components or steps or methodologies set forth in the following description or illustrated in the drawings. In the following detailed description of embodiments, numerous specific details may be set forth in order to provide a more thorough understanding of the disclosure. However, it will be apparent to one of ordinary skill in the art having the benefit of the instant disclosure that the embodiments disclosed herein may be practiced without some of these specific details. In other instances, well-known features may not be described in detail to avoid unnecessarily complicating the instant disclosure.

As used herein a letter following a reference numeral is intended to reference an embodiment of the feature or element that may be similar, but not necessarily identical, to a previously described element or feature bearing the same reference numeral (e.g., 1, 1a, 1b). Such shorthand notations are used for purposes of convenience only and should not be construed to limit the disclosure in any way unless expressly stated to the contrary.

Further, unless expressly stated to the contrary, “or” refers to an inclusive or and not to an exclusive or. For example, a condition A or B is satisfied by anyone of the following: A is true (or present) and B is false (or not present), A is false (or not present) and B is true (or present), and both A and B are true (or present).

In addition, use of “a” or “an” may be employed to describe elements and components of embodiments disclosed herein. This is done merely for convenience and “a” and “an” are intended to include “one” or “at least one,” and the singular also includes the plural unless it is obvious that it is meant otherwise.

Finally, as used herein any reference to “one embodiment” or “some embodiments” means that a particular element, feature, structure, or characteristic described in connection with the embodiment is included in at least one embodiment disclosed herein. The appearances of the phrase “in some embodiments” in various places in the specification are not necessarily all referring to the same embodiment, and embodiments may include one or more of the features expressly described or inherently present herein, or any combination of sub-combination of two or more such features, along with any other features which may not necessarily be expressly described or inherently present in the instant disclosure.

A system for receiving orders for products that may be returned for reconditioning is disclosed. Specifically, subscription-based service is disclosed, wherein a product and one or more duplicates of the product is purchased from a vendor. One of the products is sent to the user (e.g., purchaser), while the one or more duplicates are sent to a storage facility. When the product needs reconditioning (e.g., after a period of time that may be decided upon by the user), a notice is sent to the user to send the product to a reconditioning facility. The user sends the used product to the reconditioning facility, and one of the stored duplicates is sent to the user. Once the reconditioning facility reconditions the product, the product is sent to the storage facility, where it is placed in a queue to be sent to the user after a selected time period. Thus, each product and duplicate are cyclically transferred from storage facility to user, from user to reconditioning facility, and from reconditioning facility to storage facility. The system utilizes a server having processors and memory storing computer programming code to perform one or more steps of the subscription-based service. In some embodiments, the reconditioning facility is a cleaning and/or repair facility with methods for cleaning the product. In some embodiments, the product is a cosmetic device, such as a makeup brush or a set of makeup brushes.

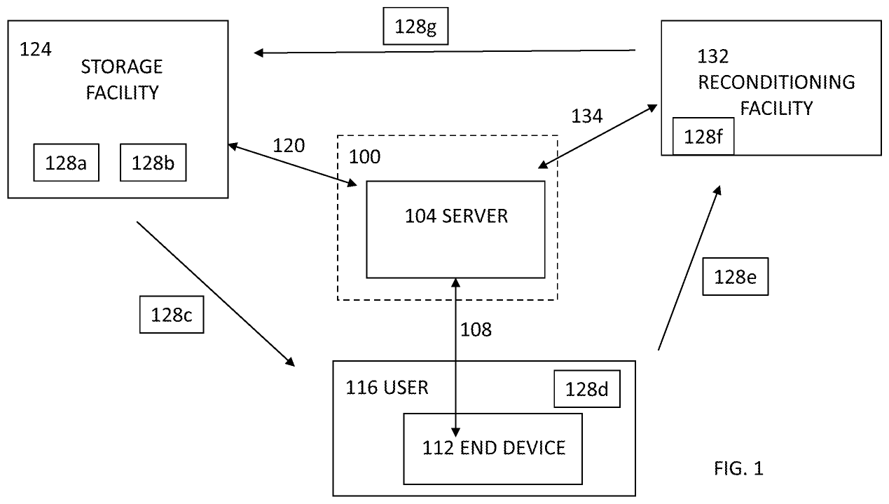

FIG. 1 is a flow diagram illustrating a system 100 for reconditioning a product, in accordance with one or more embodiments of the disclosure. In some embodiments, the system 100 includes a server 104. The server configured to receive an order request 108 from an end device 112 (e.g., a personal computing device or smartphone) sent from a user 116. Upon receiving the order request 108, the server 104 sends a request communication 120 to a storage facility 124. The storage facility 124 is configured to store one or more copies of the one or more ordered products 128a-g (e.g., 128a and 128b in FIG. 1). The set or sets of the one or more ordered products 128a-g may include one or more of the specific copies the one or more ordered products that have progressed through one or more positions within the system 100. For example, a system 100 may include two copies of the one or more ordered products (e.g., n=3) that are stored at a single point within the system 100 (e.g., 128a and 128b). In another example, the system 100 may include six copies of the one or more ordered products 128a-g that are distributed throughout the system 100. For instance, the one or more ordered products may include an original one of the one or more ordered products 128a, a first copy of the one of the one or more ordered products 128b, a second copy of the one of the one or more ordered products 128c, a third copy of the one the one or more ordered products 128d, a fourth copy of the one of the one or more ordered products 128e, a fifth copy of the one of the one or more ordered products 128f, and a sixth copy of the one or more ordered products 128g, with the one or more ordered products 128a-g essentially identical with the possible exception of a label describing the copy number of each one of the one or more ordered products 128a-g and the condition of each on of the one or more ordered products 128a-g (e.g., clean or dirty).

The storage facility may also send one of the one or more ordered products 128c to the user 116 based on the request communication 120.

Once the user 116 receives the one of the one or more ordered products 128d, the user uses one of the one or more ordered products 128d for a time interval previously details in the order request 108. Once that time interval has passed, the user 117 sends one of the one or more ordered products 128e to a reconditioning facility. After arriving at the reconditioning facility 132, the one of the one or more ordered products 128f is cleaned and/or repaired. The reconditioned one of the one or more ordered products 128g is then sent to the storage facility 124. Thus, over time, a single one of the one or more ordered products 128a-g may be sent from a storage facility to the user 116, from the user to the reconditioning facility 132, and from the reconditioning facility to the storage facility 124. One or more processing communications 134 may be sent between the reconditioning facility 132 and the server 104 to determine and track the processing of the one of the one or more ordered products 128f.

In embodiments, the number of the one or more ordered products is greater than one. For example, number of the one or more ordered products 128a-g may equal two. For instance, the storage facility may store only one of the one or more ordered products 128a and the user 116 may physically possess the other one of the one or more ordered products 128d. Upon the passing of the time interval, the user may send the physically possessed one of the one or more ordered products 128d to the reconditioning facility and then receive from the storage facility 124 the stored one of the one or more ordered products 128a. The number of the one or more ordered products may be any number greater than one including but not limited to the aforementioned two, three, four, five, ten, and 100. For example, the storage facility 124 may store fifty of the one or more ordered products 128a-g.

In embodiments, the one or more ordered products 128a-g may any type of consumer, business, or industrial product that can be ordered and reconditioned. For example, the one or more ordered products 128a-g may be configured as a consumer product including but not limited to a health and/or beauty product including but not limited to cosmetic products, pillow cases, and cleaning wiped. For instance, the cosmetic product may be configured as a makeup brush or a set of makeup brushes.

The makeup brush may be any type or kind of makeup brush including but not limited to a foundation brush, a powder brush, a fan brush, a blush brush, a bronzer brush, a concealer brush, a kabuki brush, a duo-fiber multipurpose brush, a mineral powder brush, a face contour brush, a face sponge, a highlighter brush, a blending brush, a eyeshadow brush, a flat shader eye brush, an angled shader brush, a fluffy blending brush, a crease brush, a pencil brush, an eyeliner brush, a pointed eyeliner brush, a smudger brush, a mascara wand, an eyebrow brush, a lash comb, a brow comb, a duo brow brush, a lip liner brush, a lip brush, a lip gloss applicator, or a facemask brush. The makeup brush may be made of any type of bristles including synthetic bristles or natural bristles including but not limited to sable bristles, goat bristles, badger bristles, pony bristles, squirrel bristles, Kolinsky bristles, pig bristles, and weasel bristles.

In another example, the one or more ordered products 128a-g may be any type of business or industrial product. For example, the business product may be configured as any office product including but not limited to toner cartridges and white board erasers. In another example, the industrial product may be configured as any industrial worker product including but not limited to gloves, respirator masks, or hand tools.

The storage facility 124 may configured as any type of building or room configured to store one or more of the one or more ordered products 128a-g. For example, the storage facility may be configured as a warehouse having a series of shelves. The reconditioning facility 132 may be any type of building or room configured with equipment having the capacity to recondition the one or more of the one or more ordered products 128a-g. For example, the reconditioning facility may be a building, wherein a room within the building contains equipment configured to clean the one or more of the one or more ordered products 128a-g. For instance, the reconditioning facility may be a room within a building having equipment configured to clean and/or repair makeup brushes.

The storage facility 124, the reconditioning facility 132, and the server 104 may each be configured within a separate location, or one or more of the storage facility, the reconditioning facility 132, and the server 104 may be configured within the same relative location. For example, the storage facility 124 and the reconditioning facility may be located in the same building, but the server 104 may be located within a separate building. In another example, the storage facility 124, the reconditioning facility 132, and the server 104 may all be located within the same building.

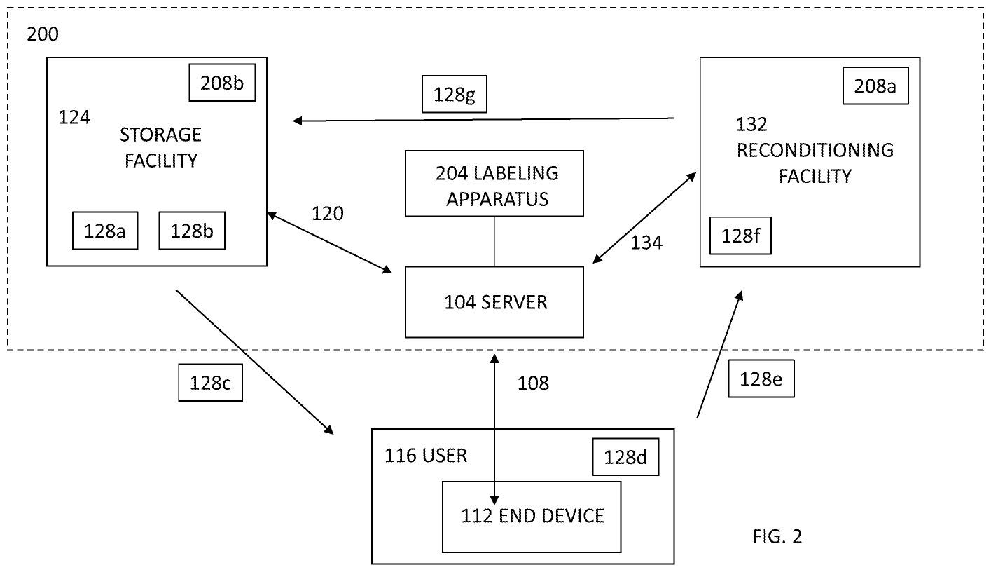

FIG. 2 is a flow diagram illustrating a system 200 for reconditioning a product, in accordance with one or more embodiments of the disclosure. The system 200 may include one of more of the components of system 100 and vice-versa. In some embodiments, the system 200 includes the storage facility 124 and the reconditioning facility 132.

In some embodiments, the system 200 includes a labeling apparatus 204 communicatively coupled to the server and configured to place or print a product label the one or more of the one or more ordered products 128a-g. The product label placed or printed onto the one or more of the one or more ordered products 128a-g may include any information including but not limited to user identification information (e.g., name of user 116, physical address of user 116, email address of user 116, account number of user 116, or account information of user 116), product identification information (e.g., stock keeping unit (SKU), or product description) and the specific copy number (e.g., duplication number). The labeling apparatus 204 may be physically located anywhere within the system. For example, the labeling apparatus may be disposed in the storage facility 124.

In some embodiments, the product label is a barcode. The barcode may be any type of barcode including but not limited to a linear barcode or a matrix barcode. For example, the barcode may be a matrix barcode configured as a quick response code (QR code). For instance, the barcode may be configured as a custom QR code.

In some embodiments, the system 200 includes one or more barcode scanners 208a, 208b. For example, the reconditioning facility 132 may include a barcode scanner 208a configured to identify one of the one or more ordered products 128f sent from the user 116. In another example, the storage facility 124 may include a barcode scanner 208b configure to identify one of the one or more ordered products 128g sent over from the reconditioning facility 132.

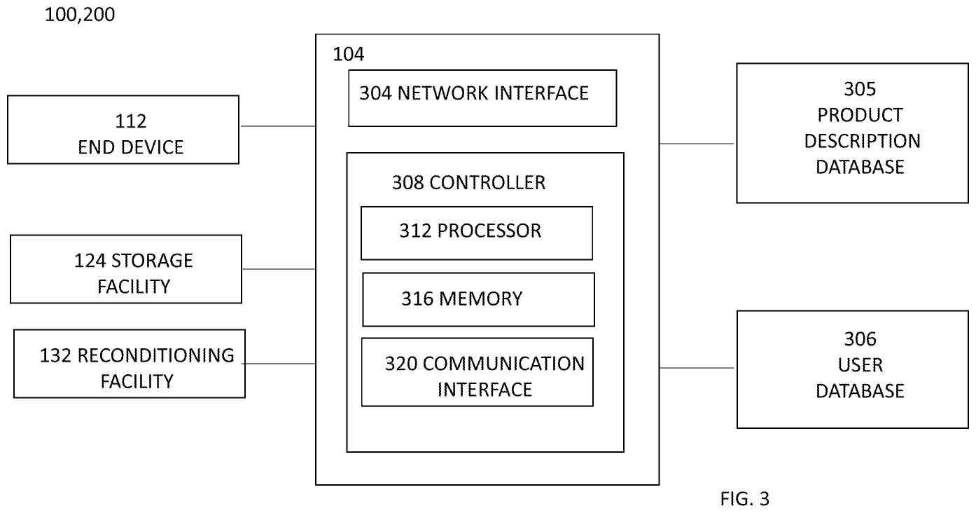

FIG. 3 is a block diagram illustrating hardware used for the system 100,200, in one or more embodiments of the disclosure. The system includes respective hardware, software and/or firmware configured to execute the carious functions or steps described herein. For example, system 100, 200 includes the server 104 and a network interface 304 that connects the server 104 to a computer network. For instance, the network interface 304 may be configured to connect the server 104 to the internet, thereby allowing the server 104 to communicated with the end device 112. In another instance, a computer within the storage facility 124 and/or the reconditioning facility 132 may communicate with the server 104 through the internet, an intranet, or other network via the network interface 304. In another example, the server 104 may be configured to communicate (e.g., send and/or receive data) with one or more databased. In particular, the server 104 may communicate with a product description database 305, and/or a user database 306. The system 100, 200 may include more than one network interfaces based on the structure of the system 100, 200. For example, the system 100, 200 may include servers for the reconditioning facility 132, the storage facility, the product description database 305, the user database 306, and/or the end device 112, with each server including one or more network interfaces 304. Therefore, the above description should not be interpreted as a limitation of the present disclosure, but merely an illustration.

The product description database 305 may be configured to include any descriptive information regarding the one or more of the one or more ordered products 128a-g. For example, the product description database may include any information including but not limited to a SKU, product description, and cleaning/repair information

The user database 306 may include any information regarding the user 116 and one or more of the one or more ordered products 128a-g associated with the user 116. For example, the user database may include any information including but not limited to user name, user address, or a status (e.g., first status or second status) of any of the one of more of the one or more ordered products 128a-g. For instance, the first status may be configured as a product location (e.g., storage facility 124, reconditioning facility 132, or user physical address) of one of the one or more ordered products 128a-g. In another instance, the second status may be configured as a condition status (e.g., new, clean, dirty, damaged, repaired) of one of the one or more ordered products 128a-g.

As illustrated in FIG. 3, the server 104 may include a controller 308 being in communication with the system 100, 200. The controller 308 is configured to receive, process, and transmit data within the system 100,200. The controller 308 include one or more processors 312 configured to perform function or step according to computer program instructions stored in a memory 316. The controller 308 is further configured to include a communication interface 320. The communication x is configured to facilitate data transfer between components of the server and/or system 100,200.

The one or more processors 312 may include any type of processing elements including but not limited to integrated circuits (e.g., application specific integrated circuits (ASIC) or central processing units (CPUs), or field programmable gate arrays (FPGA). The memory 316 may also include resident or external memory for storing data, executable code, and other resident or external memory generated by the system 100, 200. The controller 308 can execute on or more software programs embodied in a non-transitory computer readable medium (e.g., memory 316) that implements techniques described herein. In some embodiments, the controller is not limited by the materials from which it is formed or the processing mechanisms employed therein and, as such, can be implemented via semiconductor(s) and/or transistors (e.g., using electronic integrated circuit components, and so forth.

The memory 316 can be an example of tangible, computer-readable storage medium that provides storage functionality to store various data and/or program code associated with operation of the system 100 and/or controller 308, such as software programs, computer program code, and/or code segments, or other data to instruct the controller 308, and possibly other components of the system, to perform the functionality described herein (e.g., as described below). This, the memory 316 can store data, such as a program of instruction for operating the controller 308 and other components of the system. It should be noted that while a single memory 316 is described, a wide variety of types of combinations of memory 316 (e.g., tangible, non-transitionary memory) may be employed. The memory can be integral with the controller 308, can comprise stand-alone memory, or can be a combination of both. Some examples of the memory 316 can include removeable and non-removable memory components, such as random-access memory (RAM), read-only memory (ROM), flash memory (e.g., a secure digital (SD) memory card, a mini-SD memory card, and/or micro-SD memory card), solid-state drive (SSD) memory, magnetic memory, optical memory, universal serial *USB) memory devices, hard disk memory, external memory, and so forth.

In some embodiments, the computer program code includes product code configured to cause one of the one or more processors to acquire product description information of at least one of the one or more ordered products 128a-g from the product description database 305. For example, the product code may instruct the one or more processors 312 to access information about the one of the one or more ordered products 128a-g (e.g., cleaning protocols) based on product identification number information that is associated with the one of the one or more ordered products 128a-g.

In some embodiments, the computer code includes product status code configured to cause at least one of the one or more processors 312 to acquire product status information on the one of the one or more ordered products 128a-g (e.g., from the user database 306, the order request 108, or the memory 316, or other database). For example, the product status code may cause the one or more processors to acquire information relating to a first status (e.g., product location) of one of the one or more ordered products 128a-g. In another example, the product status code may cause the one or more processors to acquire information relating to a second status (e.g., condition state) of one of the one or more ordered products 128a-g.

In some embodiments, the computer code includes product transport code configured to cause the one or more processors to receive and/or acquire information associated with one of the one or more ordered products 128a-g, For example, the product transport code may receive and/or acquire information relating to the one of the one or more ordered products 128a-g including but not limited to user identification, product identification information, time interval information, and product status information.

The product transport code may also be configured to generate, based on the received and/or acquired information, an instruction to send the one of the one or more ordered products 128a-g to a selected location. For example, the instruction may comprise sending at least one of the one or more ordered products 128a-g to the storage facility 124 (e.g., from the reconditioning facility). In another example, the instruction may comprise sending at least one of the one or more ordered products 128a-g to the user address (e.g., from the storage facility). In another example, the instruction may comprise sending a notice to the user 116 requesting the user 116 to send at least one of the one or more ordered products 128a-g to the reconditioning facility 132.

In some embodiments, the notice sent to the user 116 may be configured as a message to the user 116 to send at least one of the one or more ordered products 128a-g to the reconditioning facility 132 along with a shipping label. For instance, the shipping label may a prepaid shipping label that may be adhered to a shipping container (e.g., box). The notice may also include a return container, such as an envelope of box, configured with a prepaid label.

The communication interface 320 may be operatively configured to communicate with componentry within the system 100, 200, the server 104, and/or the controller 308. For example, the communication interface 320 may be configured to retrieve data from the controller 308, transmit data for storage in the memory 316, retrieve data from storage in the memory 316, and so forth. The communication interface 320 may also be communicatively coupled with the controller 308 to facilitate data transfer between components of the system 100, 200 and the controller 308.

It should be noted that while the communication interface 320 is described as a component of the server 104, one or more components of the communication interface 320 may implemented as external components communicatively coupled to the server 104, the system 100, 200 or other components communicatively coupled to the system 100, 200 via a wired and/or wireless connection.

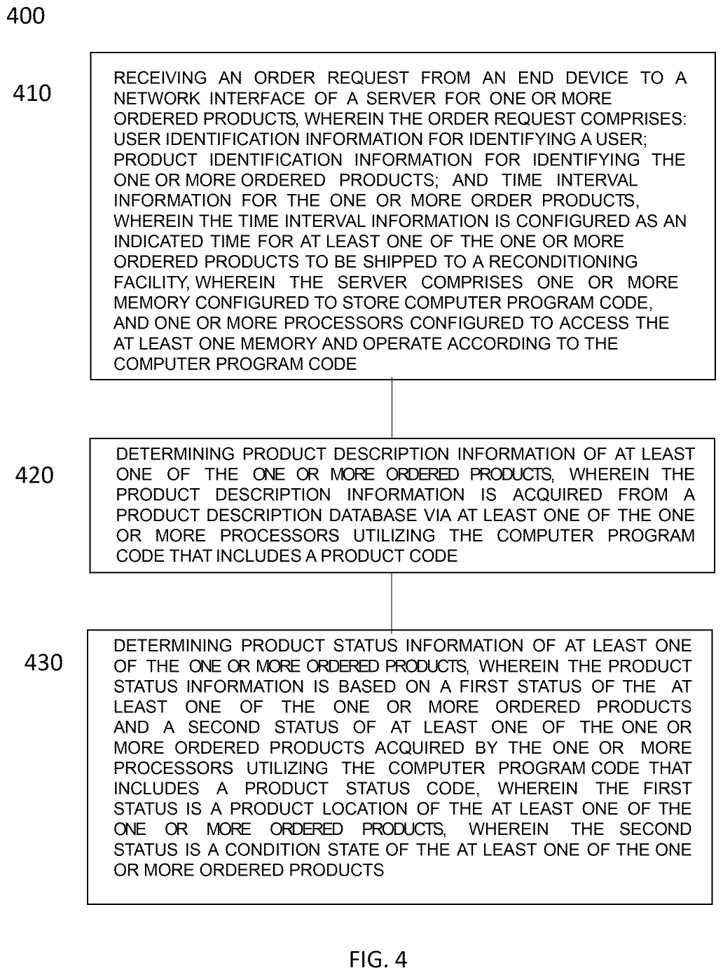

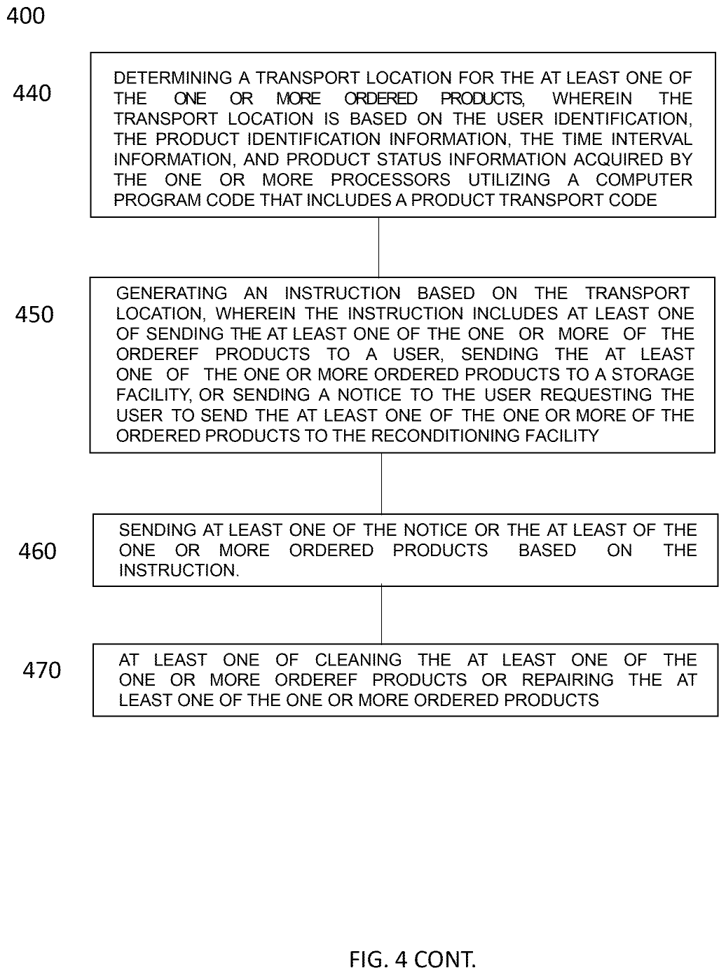

In some embodiments, the method 400 for operating a subscription-based system for vending and reconditioning the one or more ordered products 128a-g is disclosed, as shown in FIG. 4, in accordance with one or more embodiments of the disclosure. For example, the method 400 may be used to sell cosmetic devices (e.g., makeup brushes) that may be sent to the reconditioning facility 132 after a time interval, with a new set of brushes (e.g., one of the one or more ordered products 128a-g) sent to the user address from the storage facility 124.

In some embodiments, the method 400 includes a step 410 of receiving an order request 108 from an end device 112 to a network interface 304 of a server 104 for one or more ordered products 128a-g, wherein the order request 108 comprises: user identification information for identifying a user 116; product identification information for identifying the one or more ordered products 128a-g; and time interval information for the one or more ordered products 128a-g, wherein the time interval information is configured as an indicated time for at least one of the one or more ordered products 128a-g to be shipped to a reconditioning facility 132, wherein the server 104 comprises one or more memory 316 configured to store computer program code, and one or more processors 312 configured to access the at least one memory 316 and operate according to the computer program code. For example, a user 116 ordering one or more ordered products 128a-h configured as a duplicate set of brushes will send an order request 108 to the server 104 from the user's end device 112 (e.g., a smartphone) via the network interface 304. The information in the order request 108 may include the user's identification information (e.g., address or email), the product identification information (e.g., product code and/or product description), and the time interval (e.g., the brushes to be cleaned once every month).

The time interval may be configured as any period of time including but not limited to monthly, quarterly, and bi-weekly time intervals. For example, the time-interval may be set to two months. For instance, the user may receive a notice and/or a prepaid shipping container every two months for the user to send used brushes to the reconditioning facility 132 for cleaning. A user may also choose different time intervals for different products. For example, a user may order a lash brush and decide on a three-month time interval for cleaning. The same user may order a foundation brush and decide on a two-week time interval for cleaning. Time intervals may also be altered during the lifespan of the product. For example, a foundation brush may be initially purchased with a two-month time interval for cleaning, with the time interval changed at a later date to a two-week time interval.

Communication between the communication interface 304 and the end device 112 may be implemented via any software, hardware, or firmware that allows the user to communicate with the system 100 including but not limited to a website or an end user application (e.g., app). For example, the system 100 may include and/or implement a storefront website that allows a user using a laptop computer to access the system 100. For instance, the system 100 may be configured to allow the user to access a Facebook website or an internet storefront that are registered with the system 100. In another example, the system 100 may include and/or implement an app that a user may upload onto their smartphone, allowing them to access the system 100. For instance, the system 100 may be configured to allow the user to access a standalone system 100 app or an Instagram app that is registered with the system 100.

In some embodiments, the method 400 includes a step 420 of determining product description information of at least one of the one or more ordered products 128a-g, wherein the product description information is acquired from a product description database 305 via at least one of the one or more processors utilizing the computer program code that includes a product code. For example, for one of the one or more ordered products 128a-g configured as a set of brushes, the product description information acquired from the product description database 305b may include cleaning instructions for one or more brushes of the set of brushes.

In some embodiments, the method 400 includes a step 430 of determining product status information of at least one of the one or more ordered products 128a-g, wherein the product status information is based on a first status of the at least one of the one or more ordered products 128a-g and a second status of at least one of the one or more ordered products 128a-g acquired by the one or more processors 312 utilizing the computer program code that includes a product status code, wherein the first status is a product location of the at least one of the one or more ordered products 128a-g, wherein the second status is a condition state of the at least one of the one or more ordered products 128a-g. For example, for the one or more ordered products 128a-g configured as two brush sets, the one or more processors 312 may acquire product status information (e.g., from the user database, the order request 108 or other databases) and determine via product status code that a specific set of brushes (e.g., a first set of brushes) is located at the reconditioning facility 132, and that another specific set of brushes (e.g., a duplicate second set) is located at the user address (e.g., the first status configured as a product location). The one or more processors 312 may also acquire second status information for the first set of brushes as being clean, having been processed at the reconditioning facility, and for the second set of brushes as being dirty, having sent to the user address, and that the time-interval has nearly lapsed.

In some embodiments, the method 400 includes a step 440 of determining a transport location for the at least one of the one or more ordered products 128a-g, wherein the transport location is based on the user identification, the product identification information, the time interval information, and product status information acquired by the one or more processors 312 utilizing a computer program code that includes a product transport code. For example, for one of the one or more ordered products 128a-g configured as a set of brushes, the one or more processors 312 via the product transport code may determine that a set of clean brush currently located at the reconditioning facility 132 should be sent to the storage facility 124.

In some embodiments, the method 400 includes a step 450 of generating an instruction based on the transport location, wherein the instruction includes at least one of sending at least one of the one or more ordered products 128a-g to a user 116, sending the at least one of the one or more ordered products to the storage facility 124, or sending a notice to the user requesting the user to send the at least one of the one or more ordered products to the reconditioning facility 132. For example, for one of the one or more ordered products 128a-g configured as a set of brushes, that has been determined to be clean and located at the reconditioning facility 132, the processors will generate an instruction (e.g., a message to an employee of the subscription-based service, or an instruction for an automated service to proceed to the next step) for the set of brushes to be sent to the storage facility 124.

In some embodiments, the method 400 includes a step 460 of sending at least one of the notice or the at least of the one or more ordered products 128a-g based on the instruction. For example, an employee that has received the instruction to send one of the one or more ordered products 128a-g (e.g., a set of clean brushes) from the recondition facility 132 to the storage facility 124 will send the set of brushes to the storage facility.

In some embodiments, the method 400 includes a step 470 of at least one of cleaning the at least one of the one or more ordered products 128a-g or repairing the at least one of the one or more ordered products 128a-g. For example, a foundation brush received at the reconditioning facility may have damaged bristles replaced. In another example, a foundation brush received at the reconditioning facility may have a damaged or unreadable label that is reprinted or replaced. In another example, the system 200 may be configured to replace a damaged brush from a set of brushes. For instance, the system 200 may be configured to replace a damaged brush from a set of brushed for up to one year after purchase. The system may also be configured to replace missing brushed from a set of brushes.

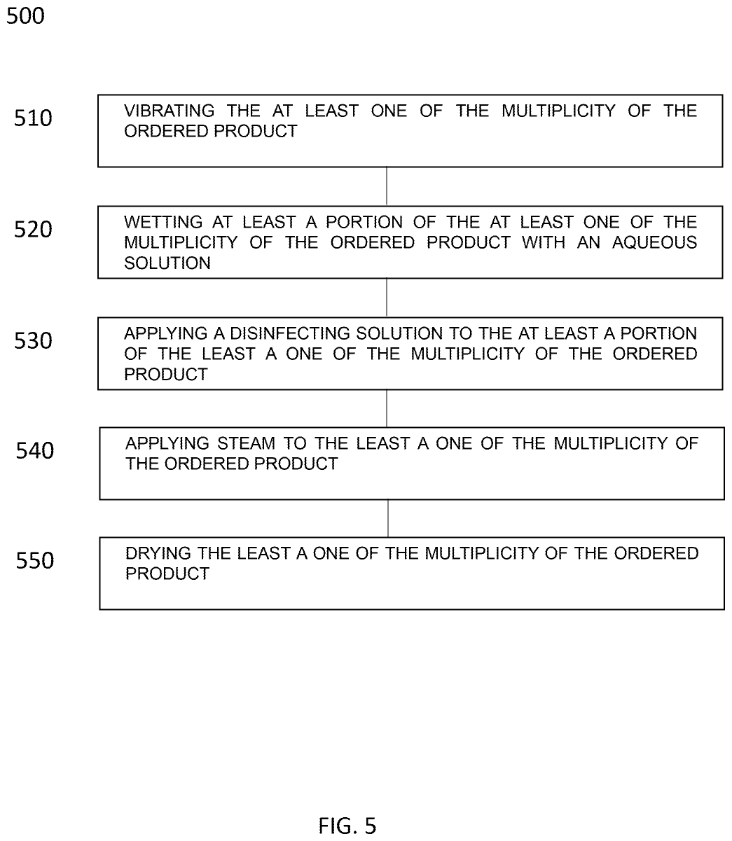

Cleaning of the at least one of the one or more ordered products may include any method or protocol for cleaning an ordered product. FIG. 5 is a flow diagram illustrating a method 500 for cleaning one of one or more ordered products 128a-g, in accordance with one or more embodiments of the disclosure. For example, the method 500 may be used for cleaning one of one or more ordered products 128a-g configured as a set of makeup brushes, or one brush of a set of makeup brushes, within the recondition facility 132.

In one or more embodiments, the method 500 may include a step 510 of vibrating the at least one of the one or more ordered products 128a-g. For example, for one of the one or more ordered products 128a-g configured as a set of makeup brushes, one or more of the makeup brushes may be vibrated by hand (e.g., shaken) or mechanically vibrated. For instance, one or more of the set of brushes may be shaken by a mechanical shaker configured as a “Style pro” mechanical shaker designed by Tom Pellereau.

In one or more embodiments, the method 500 may include a step 520 of wetting at least a portion of the at least one of the one or more ordered products 128a-g with an aqueous solution. For example, for one of the one or more ordered products 128a-g configured as a set of makeup brushes, one or more of the makeup brushes may be wetted with water. For instance, the one or more makeup brushes may be wetted with filtered, clean, room temperature water.

In one or more embodiments, the method 500 may include a step 530 of applying a disinfecting solution to the at least a portion of the least one of the one or more ordered products. For example, for one of the one or more ordered products 128a-g configured as a set of makeup brushes, one or more of the makeup brushes may have cleanser solution applied to (e.g., applied to) the bristles. For instance, the cleanser solution may be configured as a disinfecting solution. For instance, the cleanser solution may be configured as an alcohol free, paraben free, or a sulfate free solution.

In one or more embodiments, the method 500 may include a step 540 of applying steam to the least a one of the one or more ordered products. For example, for one of the one or more ordered products 128a-g configured as a set of makeup brushes, one or more of the makeup brushes may have steam applied to the bristles in a temperature range of 125° F. to 250° F. For instance, the one or more of the makeup brushes may have steam applied to the bristles in a temperature range of 150° F. to 225° F. For instance, the one or more of the makeup brushes may have steam applied to the bristles in a temperature range of 175° F. to 200° F.

In one or more embodiments, the method 500 may include a step 550 of drying the least a one of the one or more ordered products. For example, for one of the one or more ordered products 128a-g configured as a set of makeup brushes, one or more of the makeup brushes may lain flat and dried in a large bin for two days.

For cleaning brushes, the method 500, or one or more steps in the method, may be modified according to the brush type, the type of cosmetic used, the contamination (e.g., dirtiness) level of the brush, and other factors. For example, one or more steps may be modified if the type of cosmetic used is a powder makeup verses a liquid makeup. For instance, the time period for one of the steps of the method 500 may be increased for brushes contaminated with liquid cosmetic, as the brushes with liquid cosmetic often collect greater amounts of bacteria.

It is to be understood that embodiments of the methods disclosed herein may include one or more of the steps described herein. Further, such steps may be carried out in any desired order and two or more of the steps may be carried out simultaneously with one another. Two or more of the steps disclosed herein may be combined in a single step, and in some embodiments, one or more of the steps may be carried out as two or more sub-steps. Further, other steps or sub-steps may be carried in addition to, or as substitutes to one or more of the steps disclosed herein.

Although inventive concepts have been described with reference to the embodiments illustrated in the attached drawing figures, equivalents may be employed and substitutions made herein without departing from the scope of the claims. Components illustrated and described herein are merely examples of a system/device and components that may be used to implement embodiments of the inventive concepts and may be replaced with other devices and components without departing from the scope of the claims. Furthermore, any dimensions, degrees, and/or numerical ranges provided herein are to be understood as non-limiting examples unless otherwise specified in the claims.

What is claimed is:

1. A system comprising:
a server comprising:
a network interface configured to receive an order request from an end device for one or more ordered products, wherein the order request comprises:
user identification information configured to identify a user;
product identification information configured to identify the one or more ordered products; and
time interval information for the one or more ordered products, wherein the time interval information is configured as an indicated time for at least one of the one or more ordered products to be shipped to a reconditioning facility;
one or more memory configured to store computer program code;
one or more processors configured to access the at least one memory and operate according to the computer program code, wherein the computer program code includes:
product code configured to cause at least one of the one or more processors to acquire product description information of the one or more ordered products; based on the product identification number information of the one or more ordered products from a product description database;
product status code configured to cause at least one of the one or more processors to acquire product status information based on a first status of at least one of the one or more ordered products and a second status of the at least one of the one or more ordered products, wherein the first status is a product location of the at least one of the one or more ordered products, wherein the second status is a condition state of the at least one of the one or more ordered products;
product transport code configured to cause the one or more processors to receive user identification, product identification information, time interval information, and product status information, determine a transport location based on the user identification, the product identification information, the time interval information, and product status information, and generate an instruction, wherein the instruction comprises at least one of sending the at least one of the one or more ordered products to the user, sending the at least one of the one or more ordered products to a storage facility, or sending a notice to the user requesting the user to send the at least one of the one or more ordered products to the reconditioning facility.

2. The system of claim 1 further comprising a product labeling apparatus communicatively coupled to the server and configured to label the at least one of the one or more ordered products with a product label configured to include least one of the user identification information, the product identification information, or the time interval information.

3. The system of claim 2, wherein the product label comprises a barcode.

4. The system of claim 3, further comprising a barcode scanner communicatively coupled to the server and configured to scan the barcode.

5. The system of claim 1, wherein the notice comprises at least one of a mailing label or a pre-paid return container, wherein the at least one of a mailing label or prepaid return container labeled with the mailing address of the reconditioning facility.

6. The system of claim 1, wherein the reconditioning facility is configured to clean the at least one of the one or more ordered products.

7. The system of claim 6, wherein the at least one of the one or more ordered products is sent to the storage facility after cleaning.

8. The system of claim 6, wherein the at least one of the one or more ordered products is cleaned by a method comprising:
vibrating the at least one of the one or more ordered products;
wetting at least a portion of the at least one of the one or more ordered products with an aqueous solution;
applying a disinfecting solution to the at least a portion of the least a one of the one or more ordered products;
applying steam to the least one of the one or more ordered products; and
drying the least one of the one or more ordered products.

9. The system of claim 6, wherein the at least one of the one or more ordered products is configured as a cosmetic device.

10. The system of claim 9, wherein the cosmetic device is further configured as a makeup brush, or a set of makeup brushes.

11. The system of claim 1, wherein the condition state comprises at least one of a dirty state, a clean state, or a damaged state.

12. The system of claim 1, further comprising at least one of the reconditioning facility and the storage facility.

13. The system of claim 1, wherein the product location comprises at least one of the reconditioning facility, the storage facility, or a user address.

14. A method comprising:
receiving an order request from an end device to a network interface of a server for one or more ordered products, wherein the order request comprises:
user identification information for identifying a user;
product identification information for identifying the one or more ordered products; and
time interval information for the one or more ordered products, wherein the time interval information is configured as an indicated time for at least one of the one or more ordered products to be shipped to a reconditioning facility, wherein the server comprises one or more memory configured to store computer program code and one or more processors configured to access the at least one memory and operate according to the computer program code;
determining product description information of at least one of the one or more ordered products, wherein the product description information is acquired from a product description database via at least one of the one or more processors utilizing the computer program code that includes a product code.
determining product status information of at least one of the one or more ordered products, wherein the product status information is based on a first status of the at least one of the one or more ordered products and a second status of at least one of the one or more ordered products acquired by the one or more processors utilizing the computer program code that includes a product status code, wherein the first status is a product location of the at least one of the one or more ordered products, wherein the second status is a condition state of the at least one of the one or more ordered products;
determining a transport location for the at least one of the one or more ordered products, wherein the transport location is based on the user identification, the product identification information, the time interval information, and product status information acquired by the one or more processors utilizing a computer program code that includes a product transport code;
generating an instruction based on the transport location, wherein the instruction includes at least one of sending at least one of the one or more ordered products to a user, sending the at least one of the one or more ordered products to a storage facility, or sending a notice to the user requesting the user to send the at least one of the one or more ordered products to the reconditioning facility; and
sending at least one of the notice or the at least of the one or more ordered products based on the instruction.

15. The method of claim 14, further comprising labeling the at least one of the one or more ordered products.

16. The method of claim 14, further comprising at least one of:
cleaning the at least one of the one or more ordered products; or
repairing the at least one of the one or more ordered products.

17. The method of claim 16, wherein cleaning the at least one of the one or more ordered products comprises:
vibrating the at least one of the one or more ordered products;
wetting at least a portion of the at least one of the one or more ordered products with an aqueous solution;
applying a disinfecting solution to the at least a portion of the least a one of the one or more ordered products;
applying steam to the least a one of the one or more ordered products; and
drying the least a one of the one or more ordered products.

18. The method of claim 14, wherein the at least one of the one or more ordered products is configured as a cosmetic device.

19. The method of claim 18, wherein the at least one of the one or more ordered products is further configured as a makeup brush.

20. The method of claim 14, wherein the condition state includes at least a dirty state, a clean state, or a damaged state.
